(19) United States
(12) Patent Application Publication
(10) Pub. No.: US 2011/0051248 A1
(43) Pub. Date: Mar. 3, 2011

(54) Hybrid Optical Film

(75) Inventors: Zen-Yuan Chi, Hsin-Chu (TW); Yi-Wen Lin, Hsin-Chu (TW); Cheng-Chuan Lai, Hsin-Chu (TW); Shu-Ling Lin, Hsin-Chu (TW)

(73) Assignee: AU OPTRONICS CORPORATION, Hsin-Chu (TW)

(21) Appl. No.: 12/858,469

(22) Filed: Aug. 18, 2010

(30) Foreign Application Priority Data
Sep. 1, 2009 (TW) 098129372

(51) Int. Cl. G02B 5/02

(52) U.S. Cl. 359/599

(57) ABSTRACT

A hybrid optical film includes a first layer, a second layer, and a plurality of diffusion structures. The first layer has a light entering face and a first refractive index. The second layer has a second refractive index and is disposed on a face of the first layer opposite to the light entering face, wherein the second refractive index is lower than the first refractive index. The plurality of diffusion structures are disposed on the interface of the first layer and the second layer. The diffusion structure has a third refractive index, wherein the third refractive index is between the first refractive index and the second refractive index and is selectively equal to the first refractive index and the second refractive index.

### BACKGROUND OF THE INVENTION

1. Field of the Invention

This invention generally relates to a hybrid optical film. More particularly, this invention relates to a hybrid optical film for a backlight module of a liquid crystal display.

2. Description of the Prior Art

Recently, liquid crystal displays are widely used in many display devices such as televisions, computers, laptops, monitors, cell phones, digital cameras, etc.

Since liquid crystal does not emit light itself, a backlight module is needed to provide light. Therefore, a backlight module having a uniform light and sufficient brightness is pursued.

As shown in FIG. 1A, a conventional backlight module 90 includes a combination of optical films 80 and a light source module 700. The light source module 700 includes a light source 710, a light guide plate 730, a reflector 750 and a shell 770. The combination of optical films 80 includes a diffusion film 81 and a brightness enhancement film 82 for increasing the uniformity of the light distribution and the brightness of the backlight module 90. As shown in FIG. 1B, the diffusion film 81 generally includes a base layer 400 having a plurality of diffusion structures 310 disposed on its surface for enhancing the uniformity of the light distribution of the backlight module. The brightness enhancement film 82 is also called a prism sheet, wherein prism structures 500 are formed on the surface of the base layer 400. By means of the prism structures 500, light can be used and recycled in a more efficient way to increase the brightness of the backlight module.

Regarding to the conventional backlight module 90, though the uniformity of the light distribution and the brightness are respectively increased by the diffusion film 81 and the brightness enhancement film 82, the backlight module 90 demands larger space and requires a complicated assembly process because the diffusion film 81 and the brightness enhancement film 82 are individually disposed. Therefore, replacing the diffusion film 81 and the brightness enhancement film 82 with one single optical film is proposed. As shown in FIG. 1C, a plurality of diffusion structures 310 and prism structures 500 are respectively disposed on opposite faces of the base layer 400. The plurality of diffusion structures 310 are embossed toward the light source module 700. Although this design simplifies the assembly process, the brightness of the backlight module 90 is decreased because the refractive index of the diffusion structures 310 is smaller than the refractive index of the base layer 400 and the diffusion structures 310 are embossed toward the light source module 700. Therefore, it is necessary for the optical film having the diffusion structures 310 and the prism structures 500 to be improved.

### SUMMARY

It is an object of the present invention to provide a hybrid optical film for enhancing the brightness of a backlight module.

It is another object of the present invention to provide a hybrid optical film for simplifying the manufacturing process of a backlight module.

The hybrid optical film includes a first layer, a second layer, and a plurality of diffusion structures. The hybrid optical film further includes a base layer, wherein the second layer is disposed on the base layer. The base layer is preferably made of polyethylene terephthalate. The hybrid optical film further includes a prism structure layer disposed on a face of the base layer opposite to the second layer.

The first layer has a light entering face and a first refractive index. The second layer has a second refractive index and is disposed on a face of the first layer opposite to the light entering face, wherein the second refractive index is lower than the first refractive index. The plurality of diffusion structures are disposed on the interface of the first layer and the second layer. The diffusion structure has a third refractive index, wherein the third refractive index is between the first refractive index and the second refractive index and is selectively equal to the first refractive index and the second refractive index.

The plurality of diffusion structures are spheres, wherein the lower parts of the spheres are embedded into the first layer, the upper parts of the spheres are embedded into the second layer, the third refractive index is smaller than the first refractive index and is larger than the second refractive index. The diameter of the sphere is between 50 μm and 80 μm. The plurality of diffusion structures are embossed hemispheres embedded into the second layer, wherein the third refractive index is equal to the first refractive index. The diameter of the hemisphere is between 50 μm and 80 μm. The plurality of diffusion structures are embossed hemispheres embedded into the first layer, wherein the third refractive index is equal to the second refractive index. The diameter of the hemisphere is between 50 μm and 80 μm.

### BRIEF DESCRIPTION OF THE DRAWINGS

FIG. 1 is an exploded view of a conventional backlight module;

FIG. 1B is a cross-sectional view of a conventional backlight module;

FIG. 1C is a cross-sectional view of another conventional backlight module;

FIG. 2 is a schematic view of a preferred embodiment of the present invention; and

FIGS. 3-5 are schematic views showing different embodiments of the present invention.

### DETAILED DESCRIPTION OF THE PREFERRED EMBODIMENT

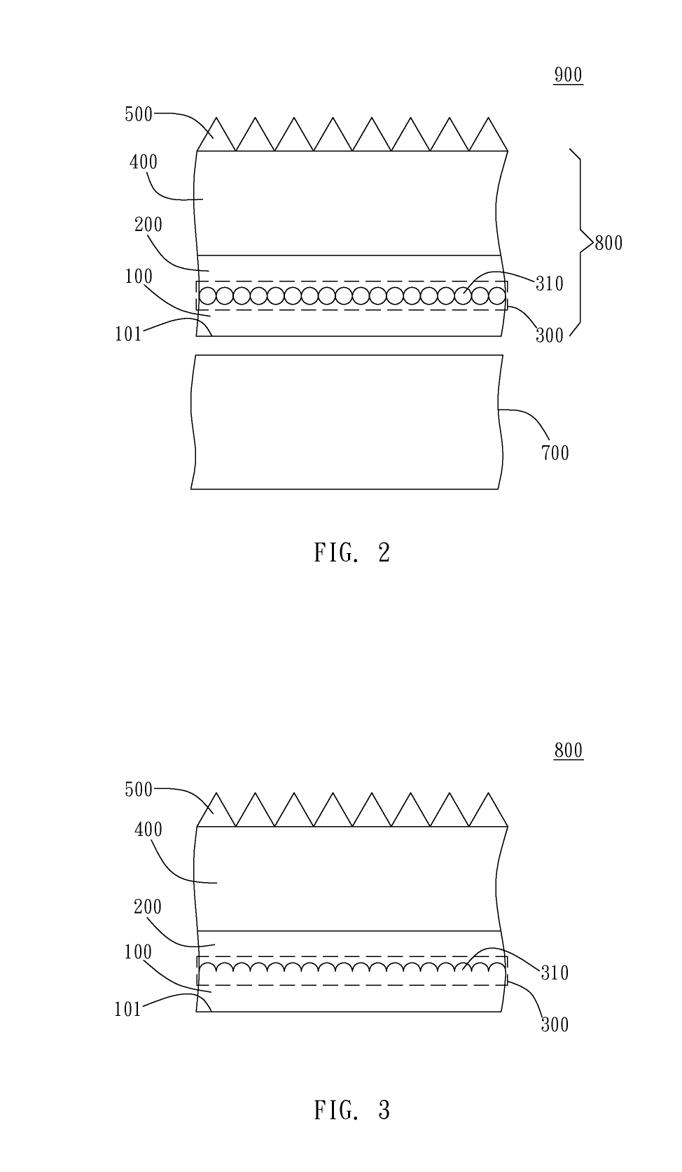

The hybrid optical film of the present invention is for use with a backlight module. In an embodiment shown in FIG. 2, a hybrid optical film 800 and a light source module 700 form a backlight module 900. The light source module 700 can include a light source, a light guide plate, a reflector, and a shell. The light source is preferably a light emitting diode. In other embodiments, however, the light source can be other types of light emitting device such as a cold cathode fluorescent lamp. In other embodiments, the light guide plate can be omitted.

As shown in FIG. 2, the hybrid optical film 800 includes a first layer 100, a second layer 200, and a plurality of diffusion structures 310. The first layer 100 has a light entering face 101 and a first refractive index. The second layer 200 has a second refractive index and is disposed on a face of the first layer 100 opposite to the light entering face 101, wherein the second refractive index is lower than the first refractive index. More particularly, the second layer 200 and the first layer 100 are disposed on the light source module 700 from the top to the bottom, wherein the light entering face 101 of the first layer 100 faces the light source module 700.

The plurality of diffusion structures 310 are disposed on the interface of the first layer 100 and the second layer 200. More particularly, a partial surface of the diffusion structure 310 is connected to the first layer 100, while the other partial surface of the diffusion structure 310 is connected to the second layer 200. The plurality of diffusion structures 310 are distributed between the first layer 100 and the second layer 200 and form a diffusion layer 300. The diffusion structure 310 has a third refractive index which is between the first refractive index and the second refractive index and is selectively equal to the first refractive index or the second refractive index. Because the diffusion structure 310 can refract the light emitted by the light source module 700, the hybrid optical film 800 of the present invention can increase the uniformity of the light distribution of the backlight module 900 by having the plurality of diffusion structures.

In an embodiment, the hybrid optical film 800 further includes a base layer 400, wherein the second layer 200 is disposed on the base layer 400. The base layer 400 can be selected from a group consisting of polyethylene terephthalate (PET), poly-methyl methacrylate (PMMA), poly-carbonate (PC), poly-styrene (PS), and a combination thereof as well as a transparent material such as glass. More particularly, the base layer 400 can be used as a base substrate for the second layer 200 to attach thereon. In an embodiment, the plurality of diffusion structures 310 are mixed with the raw material of the second layer 200 in advance and then spread on the base layer 400 by brushing, scrapping, spin coating, spraying, and etc. After the second layer 200 is formed, the first layer 100 is spread on the second layer 200 by brushing, scrapping, spin coating, spraying, etc. In other embodiments, however, the manufacturing method and the steps can be modified in accordance with the actual requirements.

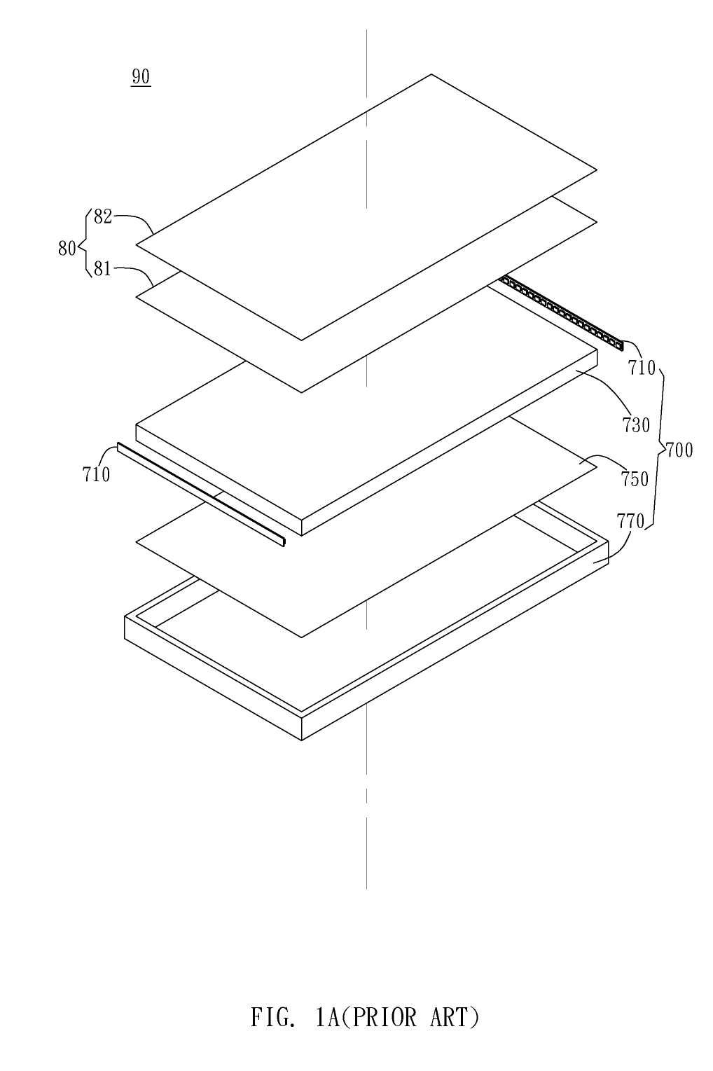

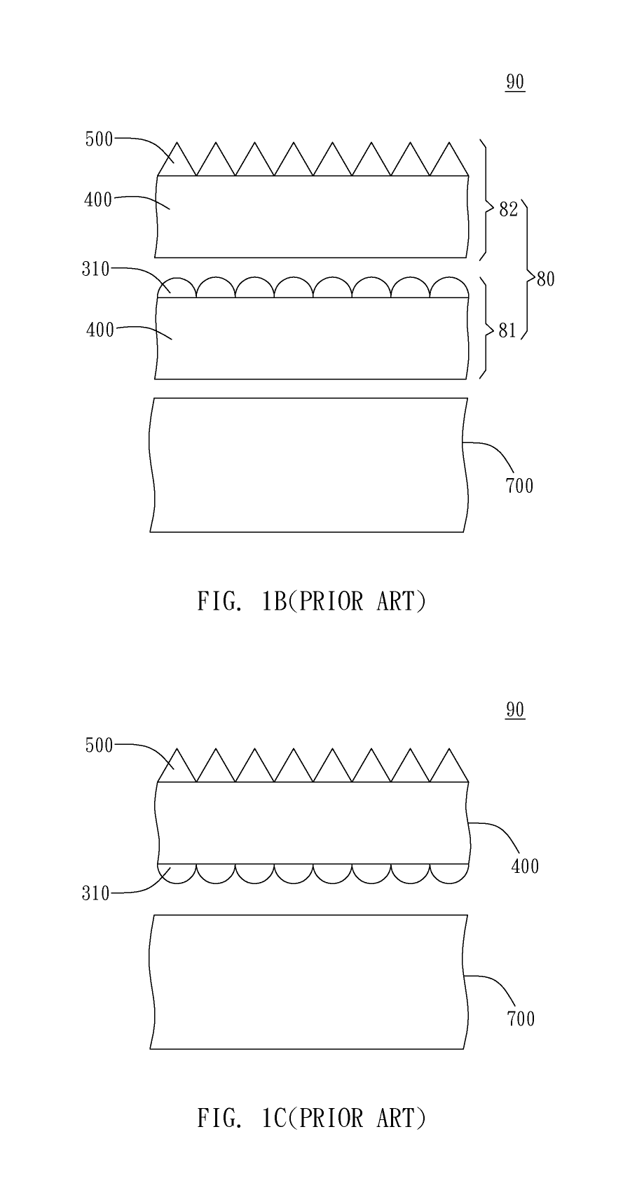

The hybrid optical film 800 further includes a prism structure layer 500 disposed on a face of the base layer 400 opposite to the second layer 200. The function of the prism structure layer 500 is to increase the light efficiency, wherein the angle, the size, the distribution, and the structure of the prism structures can be modified in accordance with the actual requirements. More specifically, comparing with the diffusion layer 81 and the brightness enhancement film 82 shown in FIG. 1B which are individually disposed as the conventional combination of optical films 80, the hybrid optical film 800 of the present invention simultaneously includes the prism structure layer 500 and the diffusion layer 300 formed by the plurality of diffusion structures 310. In other words, the diffusion layer 81 and the brightness enhancement film 82 in the prior art can be replaced by one hybrid optical film 800 of the present invention to simplify the manufacturing process of the backlight module 900. Moreover, because the third refractive index of the diffusion structure 310 is between the first refractive index and the second refractive index and is selectively equal to the first refractive index or the second refractive index, that means that the light emitted by the light source module 700 sequentially passes through the first layer 100, the diffusion layer 300, and the second layer 200 with decreasing refractive index, the light can maintain concentrated when passing through the diffusion layer 300 and the brightness of the backlight module 900 will not be significantly degraded. Therefore, the hybrid optical film 800 can enhance the brightness of the backlight module 900 by means of the prism structure layer 500, and the brightness enhancement effect is not diminished due to the disposition of the diffusion structures 310

The configuration of the diffusion structure 310 is further described below. As the embodiment shown in FIG. 2, the plurality of diffusion structures 310 are spheres, wherein the lower parts of the spheres are embedded into the first layer 100, while the upper parts of the spheres are embedded into the second layer 200. In this case, the third refractive index is preferably smaller than the first refractive index and is larger than the second refractive index. That is, the lower hemispheres of the spheres are preferably embedded into the first layer 100, and the upper hemispheres of the spheres are embedded into the second layer 200. The diameter of the sphere is preferably between 50 μm and 80 μm. In an embodiment, the plurality of diffusion structures 310 are mixed with the raw material of the second layer 200 in advance and are then spread on the base layer 400 by brushing, scrapping, spin coating, spraying, and etc. After the second layer 200 is formed, the first layer 100 is spread on the second layer 200 by brushing, scrapping, spin coating, spraying, and etc. In other embodiments, however, the manufacturing method and the steps can be modified in accordance with the actual requirements.

In a different embodiment shown in FIG. 3, the plurality of diffusion structures 310 are embossed hemispheres, which are embedded into the second layer 200. In this case, the third refractive index of the diffusion structure 310 is preferably equal to the first refractive index of the first layer 100. The diameter of the hemisphere is preferably between 50 μm and 80 μm. More particularly, the plurality of diffusion structures 310 and the first layer 100 can be integrally formed into a single piece, wherein the plurality of diffusion structures 310 are embossed hemispheres and embedded into the second layer 200 from the first layer 100. Besides, the plurality of diffusion structures 310 can be embossed hemispheres attached on the surface of the first layer 100 by scrapping, spraying, printing, and etc. after the first layer 100 is formed and are embedded into the second layer 200. In addition, a plurality of hemisphere cavities can be formed on the second layer 200 in advance, then the raw material of the first layer 100 is spread on the second layer 200 by brushing, scrapping, spin coating, spraying, and etc. Therefore, the diffusion structures 310 are spontaneously formed as hemispheres in the plurality of hemisphere cavities on the second layer 200. In other embodiments, however, the manufacturing method and the steps can be modified in accordance with the actual requirements.

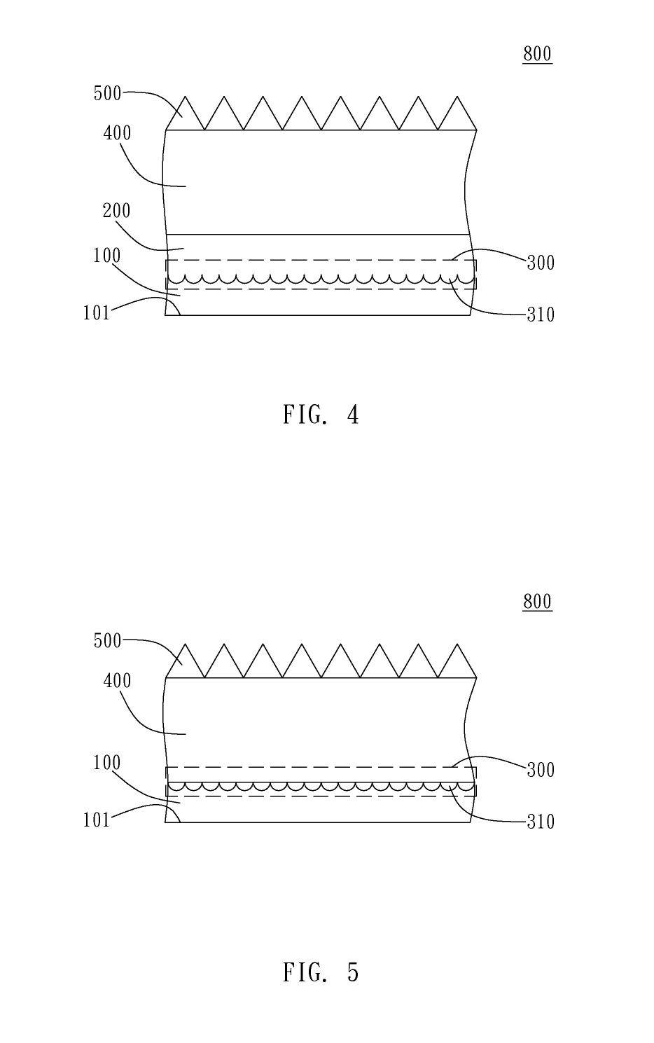

In a different embodiment shown in FIG. 4, the plurality of diffusion structures 310 are embossed hemispheres which are embedded into the first layer 100. In this case, the third refractive index of the diffusion structure 310 is equal to the second refractive index of the second layer 200. The diameter of the hemisphere is preferably between 50 μm and 80 μm. More particularly, the plurality of diffusion structures 310 and the second layer 200 can be integrally formed into a single piece, wherein the plurality of diffusion structures 310 are embossed hemispheres and embedded into the first layer 100 from the second layer 200. Besides, the plurality of diffusion structures 310 can be embossed hemispheres attached on the surface of the second layer 200 by scrapping, spraying, printing, and etc. after the second layer 200 is formed and are embedded into the first layer 100. In addition, a plurality of hemisphere cavities can be formed on the first layer 100 in advance, then the raw material of the second layer 200 is spread on the first layer 100 by brushing, scrapping, spin coating, spraying, and etc, wherein the diffusion structures 310 are spontaneously formed as hemispheres in the plurality of hemisphere cavities on the first layer 100. In other embodiments, however, the manufacturing method and the steps can be modified in accordance with the actual requirements.

In a different embodiment shown in FIG. 5, the hybrid optical film 800 of the present invention includes a base layer 400, a first layer 100, and a diffusion layer 300. The first layer 100 has a first refractive index and is disposed on the bottom side of the base layer 400. The diffusion layer 300 consists of a plurality of hemispheres acting as diffusion structures 310 disposed on the interface of the first layer 100 and the base layer 400, wherein the hemisphere has a second refractive index smaller than the first refractive index, and the hemispheres are embossed and embedded into the first layer 100. The diameter of the hemisphere is preferably between 50 μm and 80 μm. More particularly, the plurality of diffusion structures 310 and the base layer 400 can be integrally formed into a single piece using the same or different materials, wherein the plurality of diffusion structures 310 are embossed hemispheres and embedded into the first layer 100 from the base layer 400. Besides, the plurality of diffusion structures 310 can be embossed hemispheres attached on the surface of the base layer 400 by scrapping, spraying, printing, and etc. after the base layer 400 is formed and are embedded into the first layer 100. In addition, a plurality of hemisphere cavities can be formed on the first layer 100 in advance, then the raw material of the diffusion structures 310 is spread on the first layer 100 by brushing, scrapping, spin coating, spraying, and etc. Therefore, the diffusion structures 310 are spontaneously formed as hemispheres in the plurality of hemisphere cavities on the first layer 100. In other words, the embodiment shown in FIG. 5 is similar to the embodiment shown in FIG. 4 but without the second layer 200. Therefore, the thickness of the hybrid optical film 800 can be further decreased.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A hybrid optical film, comprising:
a first layer having a light entering face and a first refractive index;
a second layer having a second refractive index and being disposed on a face of the first layer opposite to the light entering face, wherein the second refractive index is lower than the first refractive index; and
a plurality of diffusion structures being disposed on an interface of the first layer and the second layer, wherein the diffusion structure has a third refractive index, the third refractive index is between the first refractive index and the second refractive index and is selectively equal to the first refractive index or the second refractive index.

2. The hybrid optical film of claim 1, further comprising a base layer, wherein the second layer is disposed on the base layer.

3. The hybrid optical film of claim 2, wherein the base layer is made of polyethylene terephthalate.

4. The hybrid optical film of claim 2, further comprising a prism structure layer disposed on a face of the base layer opposite to the second layer.

5. The hybrid optical film of claim 1, wherein the plurality of diffusion structures are spheres, wherein lower parts of the spheres are embedded into the first layer, the upper parts of the spheres are embedded into the second layer, the third refractive index is smaller than the first refractive index and is larger than the second refractive index.

6. The hybrid optical film of claim 5, wherein a diameter of the sphere is between 50 μm and 80 μm.

7. The hybrid optical film of claim 1, wherein the plurality of diffusion structures are embossed hemispheres embedded into the second layer, the third refractive index is equal to the first refractive index.

8. The hybrid optical film of claim 7, wherein a diameter of the hemisphere is between 50 μm and 80 μm.

9. The hybrid optical film of claim 1, wherein the plurality of diffusion structures are embossed hemispheres embedded into the first layer, the third refractive index is equal to the second refractive index.

10. The hybrid optical film of claim 9, wherein a diameter of the hemisphere is between 50 μm and 80 μm.

11. A hybrid optical film, comprising:
a first layer having a light entering face and a first refractive index;
a second layer having a second refractive index and being disposed on a face of the first layer opposite to the light entering face, wherein the second refractive index is lower than the first refractive index; and
a diffusion layer consisting of a plurality of spheres disposed on an interface of the first layer and the second layer, wherein the sphere has a third refractive index which is smaller than the first refractive index and larger than the second refractive index, wherein the lower parts of the spheres are embedded into the first layer, the upper parts of the spheres are embedded into the second layer.

12. The hybrid optical film of claim 11, further comprising a base layer, wherein the second layer is disposed on the base layer.

13. The hybrid optical film of claim 12, wherein the base layer is made of polyethylene terephthalate.

14. The hybrid optical film of claim 12, further comprising a prism structure layer disposed on a face of the base layer opposite to the second layer.

15. The hybrid optical film of claim 11, wherein a diameter of the sphere is between 50 μm and 80 μm.

16. A hybrid optical film, comprising:
a first layer having a light entering face and a first refractive index;
a second layer having a second refractive index and being disposed on a face of the first layer opposite to the light entering face, wherein the second refractive index is lower than the first refractive index; and
a diffusion layer consisting of a plurality of hemispheres disposed on an interface of the first layer and the second layer, wherein the hemisphere has the first refractive index, the hemispheres are embossed and embedded into the second layer.

17. The hybrid optical film of claim 16, further comprising a base layer, wherein the second layer is disposed on the base layer.

18. The hybrid optical film of claim 17, wherein the base layer is made of polyethylene terephthalate.

19. The hybrid optical film of claim 17, further comprising a prism structure layer disposed on a face of the base layer opposite to the second layer.

20. The hybrid optical film of claim 16, wherein a diameter of the hemisphere is between 50 μm and 80 μm.

21. A hybrid optical film, comprising:
a base layer;
a first layer having a first refractive index, which is disposed on a bottom side of the base layer;
a diffusion layer consisting of a plurality of hemispheres disposed on an interface of the first layer and the base layer, wherein the hemisphere has a second refractive index smaller than the first refractive index, the hemispheres are embossed and embedded into the first layer.

22. The hybrid optical film of claim 21, wherein a diameter of the hemisphere is between 50 μm and 80 μm.

23. The hybrid optical film of claim 21, further comprising a second layer having a second refractive index and being disposed between the first layer and the base layer.

24. The hybrid optical film of claim 21, wherein the base layer is made of polyethylene terephthalate.

25. The hybrid optical film of claim 21, further comprising a prism structure layer disposed on a face of the base layer opposite to the first layer.
